(19) United States
(12) Patent Application Publication
(10) Pub. No.: US 2023/0143726 A1
(43) Pub. Date: May 11, 2023

(54) INTEGRATED FRACTURING UNIT

(71) Applicant: STEWART & STEVENSON LLC, Houston, TX (US)

(72) Inventors: Chad Joost, Houston, TX (US); Chris Harvell, Houston, TX (US); Brian Sharp, Houston, TX (US); Paul Smith, Houston, TX (US); Mark Payne, Houston, TX (US)

(21) Appl. No.: 17/981,683

(22) Filed: Nov. 7, 2022

Related U.S. Application Data
(60) Provisional application No. 63/277,087, filed on Nov. 8, 2021.

(51) Int. Cl. E21B 43/12; E21B 43/26; G01M 99/00

(52) U.S. Cl. CPC E21B 43/128; E21B 43/2607; G01M 99/005

(57) ABSTRACT

An integrated fracturing system includes a fracturing pump, an electric motor positioned to drive the fracturing pump, a variable frequency drive positioned to provide variable frequency power to the electric motor, a master controller, and a diagnostic sensor. The master controller is positioned to provide energize and speed commands to the VFD. The diagnostic sensor is coupled to the electric motor positioned to measure diagnostic data. The diagnostic sensor is in communication with the master controller.

### CROSS-REFERENCE TO RELATED APPLICATIONS

This application is a nonprovisional application which claims priority from U.S. provisional application No. 63/277,087, filed Nov. 8, 2021, which is incorporated by reference herein in its entirety.

### TECHNICAL FIELD/FIELD OF THE DISCLOSURE

The present disclosure relates generally to enhanced recovery for wellbores, and specifically to hydraulic fracturing systems.

### BACKGROUND OF THE DISCLOSURE

Industrial pumps are utilized to transfer fluids from one location to another and may be used in a wide variety of applications. For example, in the oil and gas industry, industrial pumps may be utilized for transferring production fluids, drilling mud, wastewater, hydraulic fracturing fluid, or other process fluids.

Hydraulic fracturing is a process utilized in oil and gas operations to enhance recovery of minerals from a reservoir within a subterranean formation. More specifically, hydraulic fracturing involves the injection of a pressurized fluid, referred to as “fracturing fluid” into a well in order to open, generate, and/or propagate fractures or cracks within the subterranean formation. The cracks formed by the pressurized fluid increase the volume of the reservoir, which enables the release of additional minerals and improves flow of the minerals from the reservoir to the surface via the well.

Fracturing fluid, which is typically a mixture of water, gel, foam, proppant (such as sand), and/or other materials, is injected into the well via hydraulic fracturing equipment. The hydraulic fracturing equipment may include a variety of components, such as material storage tanks, blenders for mixing the fracturing fluid, and pump systems configured to increase the pressure of the fracturing fluid before the fracturing fluid is injected into the well. Traditionally, a well servicing pump system includes a well servicing pump that is driven by a combustion engine, such as a diesel engine. For example, a diesel engine may be operatively connected to a well servicing pump via a geared transmission. Generally, diesel engines usually have a large footprint, generate undesirable noise and vibrations, increase environmental impact, and can be costly to operate. Additionally, driving a well servicing pump with a diesel engine may involve the use of numerous moving parts, which may increase operating and/or maintenance costs of the hydraulic fracturing equipment.

### SUMMARY

The present disclosure provides for an integrated fracturing system. The integrated fracturing system may include a fracturing pump, an electric motor positioned to drive the fracturing pump, a variable frequency drive positioned to provide variable frequency power to the electric motor, a master controller, and a diagnostic sensor. The master controller may be positioned to provide energize and speed commands to the VFD. The integrated fracturing system may include a diagnostic sensor. The diagnostic sensor may be coupled to the electric motor positioned to measure diagnostic data. The diagnostic sensor may be in communication with the master controller.

The present disclosure also provides for a method. The method may include providing an integrated fracturing system. The integrated fracturing system may include a fracturing pump, an electric motor positioned to drive the fracturing pump, a variable frequency drive positioned to provide variable frequency power to the electric motor, a master controller, and a diagnostic sensor. The master controller may be positioned to provide energize and speed commands to the VFD. The integrated fracturing system may include a diagnostic sensor. The diagnostic sensor may be positioned to measure diagnostic data. The diagnostic sensor may be in communication with the master controller. The method may include providing diagnostic data from the diagnostic sensor to the master controller. The method may include performing diagnostics with the master controller and not the VFD.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 depicts a perspective view of an integrated fracturing system consistent with at least one embodiment of the present disclosure.

FIG. 2 depicts a perspective view of the integrated fracturing system of FIG. 1.

FIG. 3 depicts a top view of the integrated fracturing system of FIG. 1.

FIG. 4 depicts a side elevation view of the integrated fracturing system of FIG. 1.

FIG. 5 depicts a rear end elevation view of the integrated fracturing system of FIG. 1.

FIG. 6 depicts a schematic control diagram of an integrated fracturing unit consistent with at least one embodiment of the present disclosure.

FIG. 7 depicts an example of a decision flow tree consistent with at least one embodiment of the present disclosure.

FIG. 8 depicts an example of a decision flow tree consistent with at least one embodiment of the present disclosure.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

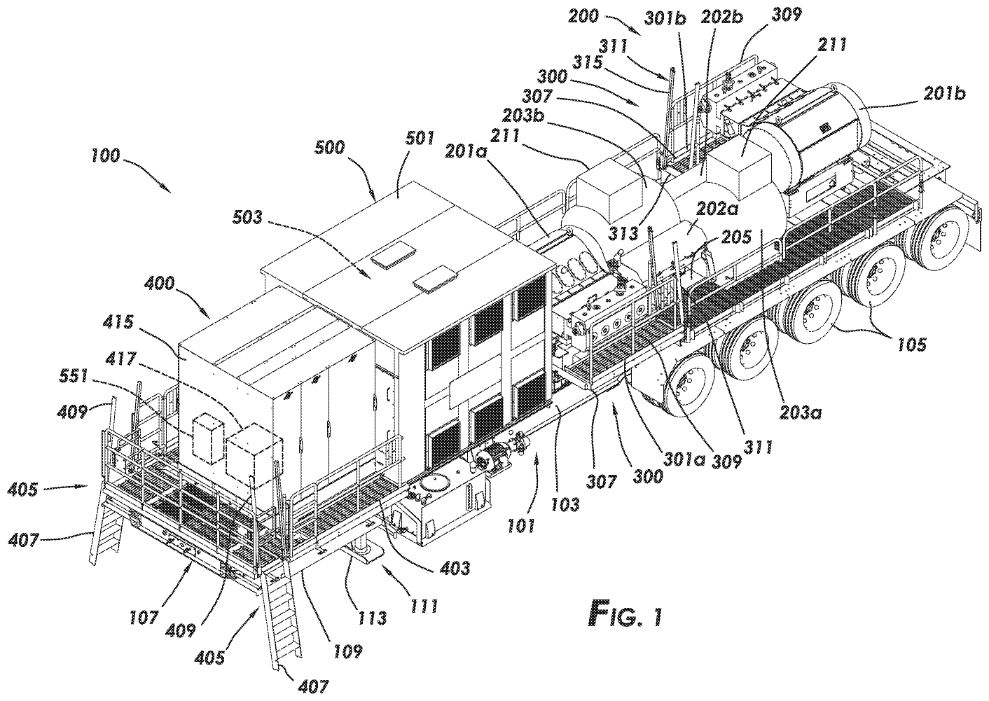

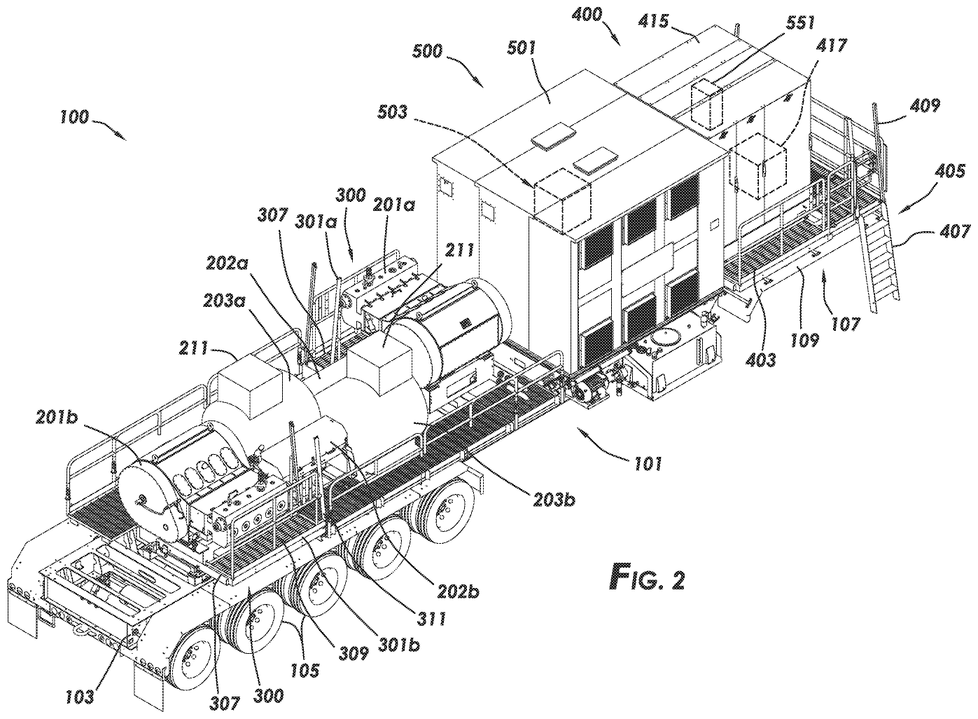

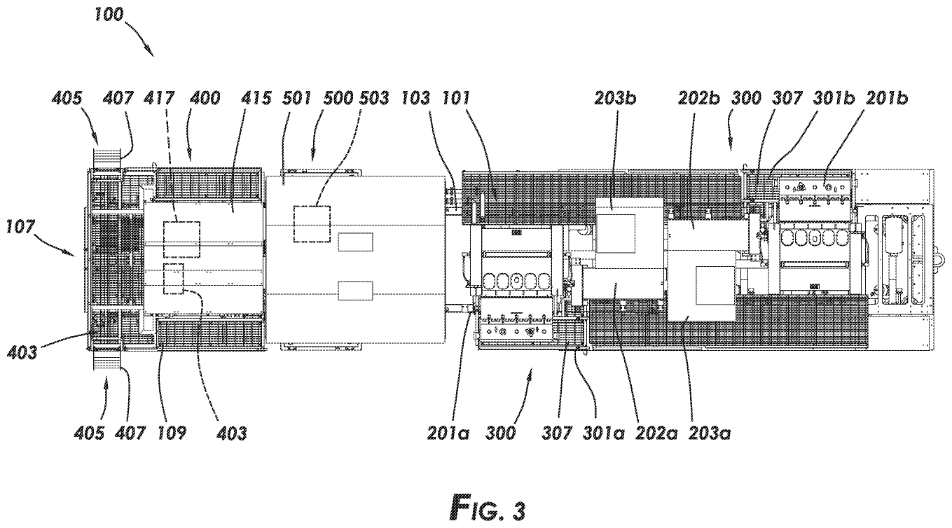

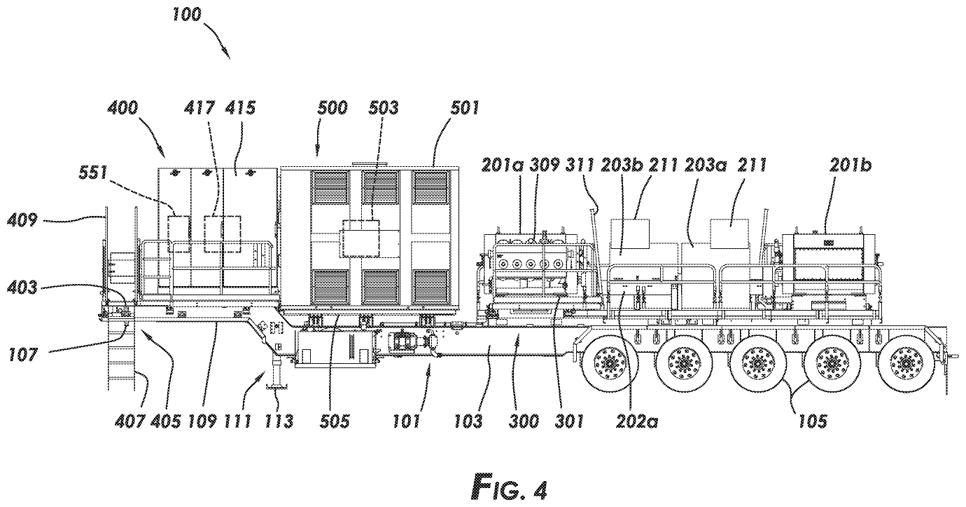

FIGS. 1-5 depicts integrated fracturing system 100. Integrated fracturing system 100 may be used, for example and without limitation, in performing hydraulic fracturing treatments in oil or gas wells. In some embodiments, integrated fracturing system 100 may be transportable as a single unit. In some embodiments, integrated fracturing system 100 may be configured to be road-transportable as a trailer, truck, or part of a trailer or truck. In other embodiments, integrated fracturing system 100 may be configured as a skid. In the embodiments shown in FIGS. 1-5, integrated fracturing system 100 is configured as a trailer.

In some embodiments, integrated fracturing system 100 may include multiple subsystems including, for example and without limitation, pump subsystem 200, slide-out platform subsystem 300, variable frequency drive (VFD) subsystem 400, and transformer subsystem 500, each of which is further discussed herein below. In some embodiments, each such subsystem may be transported together. In some embodiments, integrated fracturing system 100 may be configured such that the subsystems thereof remain operatively connected.

In some embodiments, integrated fracturing system 100 may include substructure assembly 101. In some embodiments, substructure assembly 101 may be part of a truck or may make up at least part of a trailer. Substructure assembly 101 may provide support for each subsystem of integrated fracturing system 100, as each such subsystem may couple to substructure assembly 101. Substructure assembly 101 may include one or more frame rails 103 positioned to support the subsystems of integrated fracturing system 100. Substructure assembly 101 may further include wheels 105 for use in transporting integrated fracturing system 100. Substructure assembly 101 may include coupler 107 where substructure assembly 101 is part of a trailer. Coupler 107 may be used, for example, to couple integrated fracturing system 100 to a truck for transportation of integrated fracturing system 100. In some embodiments, substructure assembly 101 may include gooseneck 109. Gooseneck 109 may assist with the transportability of integrated fracturing system 100 when integrated fracturing system 100 is coupled to a truck.

In some embodiments, substructure assembly 101 may include leveling system 111. Leveling system 111 may include one or more legs 113 coupled to substructure assembly 101 and positioned to extend from substructure assembly 101 to the ground once integrated fracturing system 100 is transported to the desired location. In some embodiments, legs 113 may be extended or retracted such that substructure assembly 101 and the subsystems of integrated fracturing system 100 are level during operation thereof. In some embodiments, legs 113 may be retractable such that legs 113 do not interfere with the transportation of integrated fracturing system 100.

In some embodiments, substructure assembly 101 may include a cable tray. The cable tray may be positioned between and coupled to frame rails 103 of substructure assembly 101 and may extend from the front of substructure assembly 101 at gooseneck 109 to the rear end of substructure assembly 101. In some embodiments, the cable tray may extend beneath the subsystems of integrated fracturing system 100 and may be used to house one or more cables and lines including, for example and without limitation, electrical power cables, data or communication cables, hydraulic lines, pneumatic lines, or any other cable or line used in integrated fracturing system 100. In some embodiments, the cables and lines within the cable tray may remain operatively coupled to the subsystems of integrated fracturing system 100 during transportation such that the need to reconnect each cable or line each time integrated fracturing system 100 is to be put into use is reduced.

In some embodiments, the cable tray may include a main power line positioned to receive electrical power from an external power supply with a single connection to integrated fracturing system 100. In some embodiments, the primary input cable may include a connection at one or both ends of the cable tray such that electrical power may be provided to integrated fracturing system 100 from either the front or rear end of integrated fracturing system 100. In some embodiments, power supply may be coupled to the primary input cable of integrated fracturing system 100 at a location spaced apart from a hazardous piece of equipment depending on the mode of operation of integrated fracturing system 100. In some embodiments, the primary input cable may extend to transformer subsystem 500 as further described herein below.

In some embodiments, substructure assembly 101 may include additional cable trays. For example and without limitation, substructure assembly 101 may include a cable tray that extends between VFD subsystem 400 and pump subsystem 200 and may support one or more electric cables including power supply cables and communications cables that extend between VFD subsystem 400 and pump subsystem 200. Such a cable tray may allow for the electrical connections between VFD subsystem 400 and pump subsystem 200 to remain in operative communication during transportation of integrated fracturing system 100.

Integrated fracturing system 100 may include pump subsystem 200. In some embodiments, pump subsystem 200 may be located at a rear location of integrated fracturing system 100. In some embodiments, pump subsystem 200 may include fracturing pumps 201a, 201b and motors 203a, 203b. Motors 203a, 203b may be electrically powered. Pump subsystem 200 may be coupled to frame rails 103. Fracturing pump 201a may be operatively coupled to motor 203a and fracturing pump 201b may be operatively coupled to motor 203b.

In some embodiments, fracturing pump 201a and motor 203a and fracturing pump 201b and motor 203b may be operated independently. The inclusion of multiple fracturing pumps 201a, 201b and respective motors 203a, 203b may, for example and without limitation, provide redundancy for operations and may provide dual pumping capability from a single integrated fracturing system 100.

In some embodiments, fracturing pumps 201a, 201b and motors 203a, 203b may be coupled to fracturing pump skid 205. Fracturing pump skid 205 may be selectively decoupleable from substructure assembly 101 of integrated fracturing system 100 such that fracturing pumps 201a, 201b and motors 203a, 203b may be assembled apart from substructure assembly 101. Such an arrangement may, for example and without limitation, allow for fracturing pump skid 205 to be specifically configured for the specific configuration of fracturing pumps 201a, 201b and motors 203a, 203b, thereby making the process of mounting and aligning fracturing pumps 201a, 201b and the respective motors 203a, 203b simpler than an arrangement in which such mounting and alignment were done to substructure assembly 101 directly. Additionally, in some embodiments, the use of such a fracturing pump skid 205 separate from substructure assembly 101 may allow fracturing pumps 201a, 201b and motors 203a, 203b having different configurations to be used with integrated fracturing system 100 by using different fracturing pump skids 205. In some embodiments, each such fracturing pump skid 205 may be adapted to be received by substructure assembly 101 of integrated fracturing system 100. Additionally, by coupling fracturing pumps 201a, 201b and motors 203a, 203b to frame rails 103 of substructure assembly 101 with fracturing pump skid 205, fracturing pumps 201a, 201b and motors 203a, 203b may be removed and replaced with a replacement pump subsystem 200 in the case of failure of any of fracturing pumps 201a, 201b or motors 203a, 203b.

In some embodiments, fracturing pumps 201a, 201b and motors 203a, 203b, may be positioned off the centerline of substructure assembly 101. In some such embodiments, fracturing pump 201a and motor 203a may be offset in a first lateral direction and fracturing pump 201b and motor 203b may be offset in a second lateral direction. In such an arrangement, fracturing pump 201a and motor 203a may be positioned at least partially alongside fracturing pump 201b and motor 203b. In such an arrangement, the overall length of pump subsystem 200 may be reduced as compared to an arrangement in which fracturing pump 201a and motor 203a are positioned directly inline with fracturing pump 201b and motor 203b.

In some embodiments, fracturing pump 201a and motor 203a may be arranged in the opposite direction as fracturing pump 201b and motor 203b. For example, in some embodiments, fracturing pump 201a and motor 203a may be arranged such that fracturing pump 201a is in front of motor 203a, while fracturing pump 201b and motor 203b are arranged such that fracturing pump 201b is behind motor 203b. In some embodiments, one or more components of fracturing pump 201a and motor 203a may be at least partially longitudinally aligned with one or more components of fracturing pump 201b and motor 203b. In some such embodiments, where motors 203a, 203b are less wide than fracturing pumps 201a, 201b, motor 203a may be positioned at least partially abeam of motor 203b, such that the width of pump subsystem 200 may be reduced as compared to an arrangement in which fracturing pumps 201a, 201b and motors 203a, 203b are positioned entirely abeam.

In some embodiments, fracturing pump 201a may be operatively coupled to motor 203a by shaft assembly 202a and fracturing pump 201b may be operatively coupled to motor 203b by shaft assembly 202b. In some embodiments, shaft assemblies 202a, 202b may be narrower than fracturing pumps 201a, 201b and motors 203a, 203b. In some such embodiments, fracturing pumps 201a, 201b, shaft assemblies 202a, 202b, and motors 203a, 203b may be arranged such that shaft assembly 202a is aligned with motor 203b and shaft assembly 202b is aligned with motor 203a. In such an arrangement, the overall width of pump subsystem 200 may be reduced as compared to an arrangement in which fracturing pumps 201a, 201b or motors 203a, 203b are positioned directly abreast.

In some embodiments, pump subsystem 200 may include motor cooling system 211. Motor cooling system 211 may include, for example and without limitation, one or more electrically driven fans positioned on each of motors 203a, 203b.

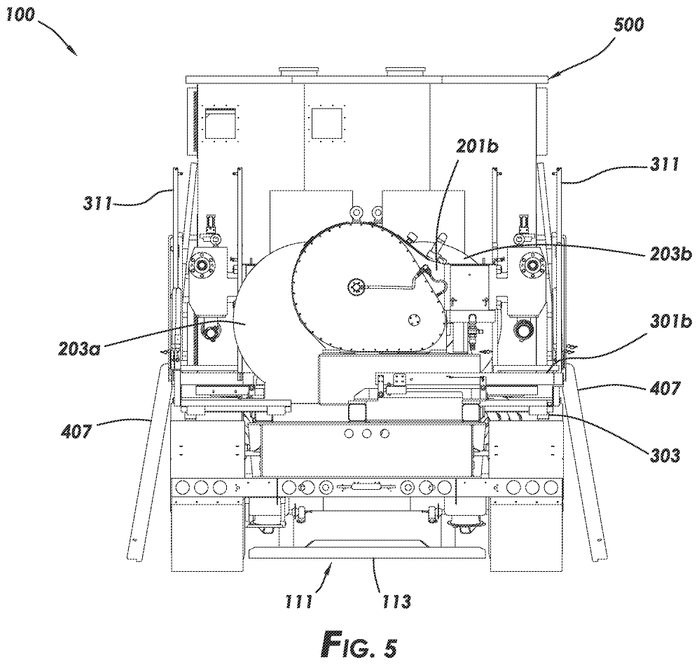

In some embodiments, integrated fracturing system 100 may include slide-out platform subsystem 300. Slide-out platform subsystem 300 may, in some embodiments, be located adjacent to pump subsystem 200. In such embodiments, slide-out platform subsystem 300 may include movable platforms 301a, 301b, shown in the retracted position in FIGS. 1-5. Movable platforms 301a, 301b may be slidably coupled to frame rails 103 of substructure assembly 101 by one or more slide rails 303 as shown in FIG. 5. In some embodiments, movable platforms 301a, 301b may move between a retracted position and an extended position manually. In some embodiments, movable platforms 301a, 301b may move between a retracted position and an extended position by one or more actuators. In some embodiments, the actuators may be electrically powered. The actuators may include, for example and without limitation, a screw drive, a chain drive, a worm drive, or a linear actuator. Movable platforms 301a, 301b may each include floor 307. In some embodiments floor 307 may be formed as a grated floor.

In some embodiments, movable platforms 301a, 301b may each include safety railings 309. In some embodiments, movable platforms 301a, 301b may each include ladder assembly 311. Ladder assembly 311 may include ladder 313 and handrails 315. Handrails 315 may be rigidly coupled to and may extend upward from floor 307. In some embodiments, ladder 313 may be pivotably coupled to floor 307 such that ladder 313 may pivot between a raised position and a lowered position. In other embodiments, ladder 313 may be slidingly coupled to handrails 315 such that ladder 313 may slide between the raised and lowered positions. When in the raised position, ladder 313 may be located within the perimeter of floor 307 such that movable platforms 301a, 301b may be positioned in the retracted position. When in the lowered position, ladder 313 may extend from floor 307 to the ground such that floor 307 of movable platforms 301a, 301b may be accessible via ladder 313. In some embodiments, ladder 313 may extend between floor 307 and the ground. In some embodiments, ladder 313 may extend vertically or may extend at an angle to the vertical, such as at an angle between 0° and 60°, 5° and 45°, or 5° and 25° to the vertical. In such an embodiment, use of ladder 313 positioned at an angle to the vertical may be simplified as compared to a vertical ladder.

In some embodiments, ladder 313 may be positioned within handrails 315 when ladder 313 is in the raised position. In some embodiments, one or more retaining mechanisms may be positioned in ladder 313 or handrails 315 which may be used to retain ladder 313 in the raised position. For example, in some embodiments, the retaining mechanism may include a shaft, such as for example, a bolt adapted to pass through a hole formed in each of ladder 313 and handrails 315 such that ladder 313 remains in the raised position when the retaining mechanism is positioned therein. In some embodiments, a securing device such as a cotter pin or nut may be used to retain the retaining mechanism in the locked position.

In some embodiments, movable platforms 301a, 301b may each include a safety gate. The safety gate may be positioned to extend across the opening between handrails 315. The safety gate may be pivotably coupled to handrails 315 or safety railings 309 such that the safety gate pivots only inwardly, thereby preventing or reducing the chances that a user will inadvertently step off of floor 307 in the direction of ladder assembly 311.

When in the retracted position, movable platforms 301a, 301b may, in some embodiments, remain within the outer perimeter of substructure assembly 101 to facilitate transportation of integrated fracturing system 100. Movable platforms 301a, 301b may be extended such that equipment of integrated fracturing system 100 may be more easily accessible. For example and without limitation, where movable platform 301 is located adjacent pump subsystem 200, access to fracturing pump 201a or 201b may be facilitated by the extension of the respective movable platform 301a or 301b. Ladder 313 may be lowered to the ground, allowing a user to access floor 307 of movable platform 301a or 301b and thereby access the respective fracturing pump 201a or 201b and motor 203a or 203b.

In some embodiments, with reference to FIG. 1, integrated fracturing system 100 may include VFD subsystem 400. VFD subsystem 400 may be mechanically coupled to substructure assembly 101, such as to frame rails 103.

VFD subsystem 400 may include VFD platform 403, accessible from the ground by one or more ladder assemblies 405. Each ladder assembly 405 may include ladder 407 and handrails 409. Handrails 409 may be rigidly coupled to and may extend upward from VFD platform 403. In some embodiments, ladder 407 may be pivotably coupled to VFD platform 403 such that ladder 407 may pivot between a raised position and a lowered position. In other embodiments, ladder 407 may be slidingly coupled to handrails 409 such that ladder 407 may slide between the raised and lowered positions. When in the raised position, ladder 407 may be located within the perimeter of VFD platform 403. In some embodiments, ladder 407 may be positioned within handrails 409 when ladder 407 is in the raised position. When in the lowered position, ladder 407 may extend from VFD platform 403 to the ground such that VFD platform 403 may be accessible via ladder 407. In some embodiments, ladder 407 may extend to the ground at an angle from VFD platform 403, In such an embodiment, use of ladder 407 may be simplified as compared to a vertical ladder.

In some embodiments, VFD subsystem 400 may include VFD enclosure 415, which may protect VFD 417 from the surrounding environment and may protect users from encountering high voltages within VFD enclosure 415. VFD enclosure 415 may, in some embodiments, be secured to VFD platform 403 by one or more vibration isolation mounts to, for example and without limitation, provide vibration and motion damping between VFD enclosure 415 and substructure assembly 101 during transportation of integrated fracturing system 100. Such damping may, without being bound to theory, mitigate the risk of damaging VFD 417 as well as causing damage to substructure assembly 101 due to movement or torsional loading caused by VFD 417 during travel over uneven terrain.

VFD 417 may provide power to motors 203a, 203b and may control the operation of motors 203a, 203b by, for example and without limitation, controlling the speed and torque of motors 203a, 203b and thereby the pump rate of fracturing pumps 201a or 201b by varying the voltage and current supplied to the respective motor 203a, 203b and by varying the frequency of the power supplied to motor 203a, 203b.

VFD 417 may, in some embodiments, be controlled by an operator positioned on VFD platform 403, may be controlled remotely, or may operate at least partially autonomously in response to predetermined operating parameters. In some embodiments in which VFD 417 is controlled remotely, VFD 417 may be controlled by a central control system used to manage multiple integrated fracturing systems 100 positioned in a wellsite. In some embodiments, VFD subsystem 400 may include a radiator and fan assembly for thermal management of VFD 417.

In some embodiments, VFD subsystem 400 may include a unit control system, which may be accessible from VFD platform 403 of VFD subsystem 400. In some embodiments, an operator may control one or more aspects of the operation of integrated fracturing system 100 through the unit control system. In some embodiments, for example and without limitation, the unit control system may be operatively coupled to other subsystems of integrated fracturing system 100 through one or more communication cables.

In some embodiments, integrated fracturing system 100 may include transformer subsystem 500. Transformer subsystem 500 may include transformer enclosure 501. Transformer enclosure 501 may house transformer 503, may protect transformer 503 from the surrounding environment, and may protect users from the high voltages found within transformer enclosure 501 during operation of transformer 503.

In some embodiments, transformer subsystem 500 may include transformer base 505. Transformer base 505 may support transformer enclosure 501 and transformer 503. Transformer base 505 may be coupled to frame rails 103 of substructure assembly 101. In some embodiments, transformer base 505 may be coupled to substructure assembly 101 via isolation mounts. Isolation mounts may, for example, provide vibration and motion damping between transformer subsystem 500 and substructure assembly 101 during transportation of integrated fracturing system 100. Such damping may, without being bound to theory, mitigate the risk of damaging transformer 503 as well as causing damage to substructure assembly 101 due to movement or torsional loading caused by transformer subsystem 500 during travel over uneven terrain. In some embodiments, damping may further reduce transmission of vibrations caused by transformer 503 to the rest of integrated fracturing system 100 during operation of transformer 503.

In some embodiments, VFD 417 may be controlled by master controller 551. Master controller 551 may be positioned on substructure assembly 101. Master controller 551 may be operatively coupled to VFD 417 such that master controller 551 provides instruction to VFD 417 including, for example and without limitation, commands to energize and control the speed of electric motors 203a, 203b driven by VFD 417. Master controller 551 may thereby control fracturing pump 201a, 201b and thus control the speed and amount of fluid pumped by fracturing pump 201a, 201b from hydraulic fracturing fluid supply 621 to hydraulic fracturing fluid output 623. In some embodiments, hydraulic fracturing fluid supply 621 may be coupled to a source of fluid including, for example and without limitation, a reservoir, tank, or other equipment such as blenders. Hydraulic fracturing fluid output 623 may be coupled to a wellbore via a frac tree coupled thereto.

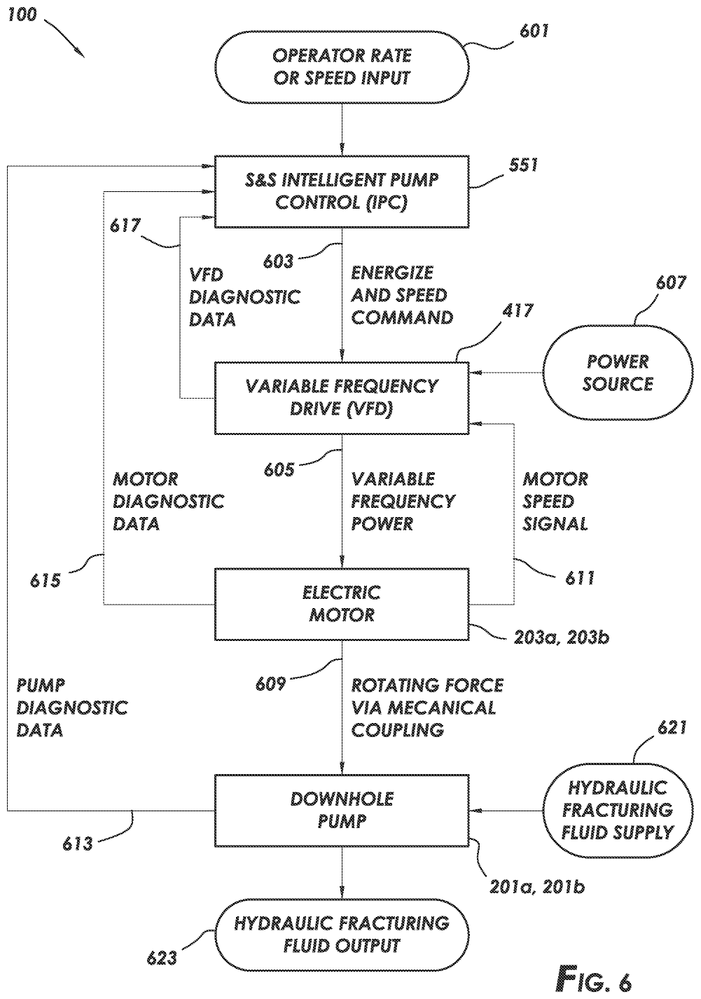

FIG. 6 depicts a schematic control diagram of integrated fracturing system 100 consistent with at least one embodiment of the present disclosure. As shown, master controller 551 may be positioned to receive input from an operator as to speed or rate of flow of fracturing pump 201a, 201b at operator input 601. Master controller 551 may interpret operator input 601 as well as other parameters as further discussed below and output energize and speed commands 603 to VFD 417. VFD 417 may receive energize and speed commands 603 and provide variable frequency power 605 to motor 203a, 203b. VFD 417 may include one or more power electronics components such as rectifiers, switches, and inverters positioned to convert input power 607 into variable frequency power 605 for motor 203a, 203b. Variable frequency power 605 may be single or multiphase.

Based on variable frequency power 605 received by motor 203a, 203b, motor 203a, 203b may be energized and the rotor thereof is rotated. Each rotor is coupled to fracturing pump 201a, 201b by mechanical coupling 609. Thus, the rotation of the rotor of each motor 203a, 203b causes rotation of components of the respective fracturing pump 201a, 201b, thereby providing impetus for the movement of fluid from hydraulic fracturing fluid supply 621 to hydraulic fracturing fluid output 623 and thereby into the wellbore as discussed herein above.

In some embodiments, each motor 203a, 203b may include a speed sensor which may be in communication with VFD 417 to provide motor speed signal 611. Motor speed signal 611 may be used by VFD 417 to modulate variable frequency power 605 such that the speed of motor 203a, 203b matches the speed commanded by master controller 551 via energize and speed commands 603.

In some embodiments, one or more components of integrated fracturing system 100 may include one or more diagnostic sensors. In such embodiments, the diagnostic sensors may provide diagnostic data to master controller 551. As shown in FIG. 6, fracturing pump 201a, 201b may provide pump diagnostic data 613, motor 203a, 203b may provide motor diagnostic data 615, and VFD 417 may provide VFD diagnostic data 617 to master controller 551. For example and without limitation, diagnostic data may include one or more of battery voltage; motor bearing drive-end temperature; motor bearing non-drive-end temperature; coolant pressure; coolant temperature; discharge pressure; discharge rate; fluid end strokes; grease system active; motor RPM; motor feedback hertz; number of plungers; overpressure trip point; plunger diameter; plunger stroke; power end strokes; pump charge pressure; pump efficiency; pump gear ratio; pump hours; pump id; pump lube oil pressure; pump lube oil temperature; pump discharge total; motor RPM request; VFD current DAC; VFD current RPM; VFD drive current percent; VFD overload percent remaining; VFD frequency feedback hertz; VFD maximum RPM; VFD motor current amperes; VFD motor overload percent remaining; VFD motor power kW; VFD motor voltage; VFD speed feedback percent; VFD speed feedback RPM; VFD CDC temperature; VFD IGBT bridge 1 temperature; VFD IGBT bridge 2 temperature; VFD IGBT bridge 3 temperature; VFD rectifier bridge temperature; VFD maximum CDC temperature; VFD active current amperes; VFD reactive current amperes; VFD speed reference percent; VFD torque demand percent; remote watchdog enabled; motor winding A temperature; motor winding B temperature; motor winding C temperature. Sensors may include, for example and without limitation, one or more pressure transducers, temperature transducers, speed sensors, and power measurement devices. As an example, master controller 551 may use motor diagnostic data 615 to provide reliable operation of motor 203a, 203b and reduce or prevent damage to motor 203a, 203b during operation thereof

Additionally, diagnostic data may be gathered from other system controllers by master controller 551, allowing master controller 551 to integrate diagnostic data from multiple subsystems of integrated fracturing system 100, thereby allowing for a more detailed and complete diagnostic system. For example and without limitation, master controller 551 may gather information from one or more of a fan controller; pressure transducers associated with a pump; accelerometers associated with a pump; lube oil pressures and temperature sensors; motor bearing temperature sensors, and motor winding temperature sensors.

As shown in FIG. 6, diagnostic data is sent to master controller 551 and not to VFD 417. VFD 417 therefore is not used to perform diagnostics. In some embodiments, diagnostic data gathered by master controller 551 may be used, for example and without limitation, for troubleshooting issues, building predictive models for forensic analysis, optimized performance, managing of health of components, and for generating preventative decision tress for safety and reliability.

In some embodiments, master controller 551 may provide alerts to a user or otherwise manage the performance of integrated fracturing system 100 according to one or more alert conditions. For example and without limitation, alert conditions may be based on the monitoring of one or more of motor bearing drive end; motor bearing non-drive end; motor blower; coolant fan motor; coolant level; coolant recirculation motor; coolant pressure; coolant temperature; emergency stop; grease level low; lube oil level; phase A winding temperature; phase B winding temperature; phase C winding temperature; pump charge pressure; pump discharge pressure; pump oil pressure; pump oil temperature; pump speed; shutdown; VFD fault; watchdog local timeout; or watchdog remote timeout. In some embodiments, alerts may be provided as one or more annunciations on one or more displays or other human interface devices. In some embodiments, an alert condition may cause master controller 551 to change the mode of operation or modify the operation of one or more components of integrated fracturing system 100 including, in some instances, the termination of one or more operations of one or more components of integrated fracturing system 100.

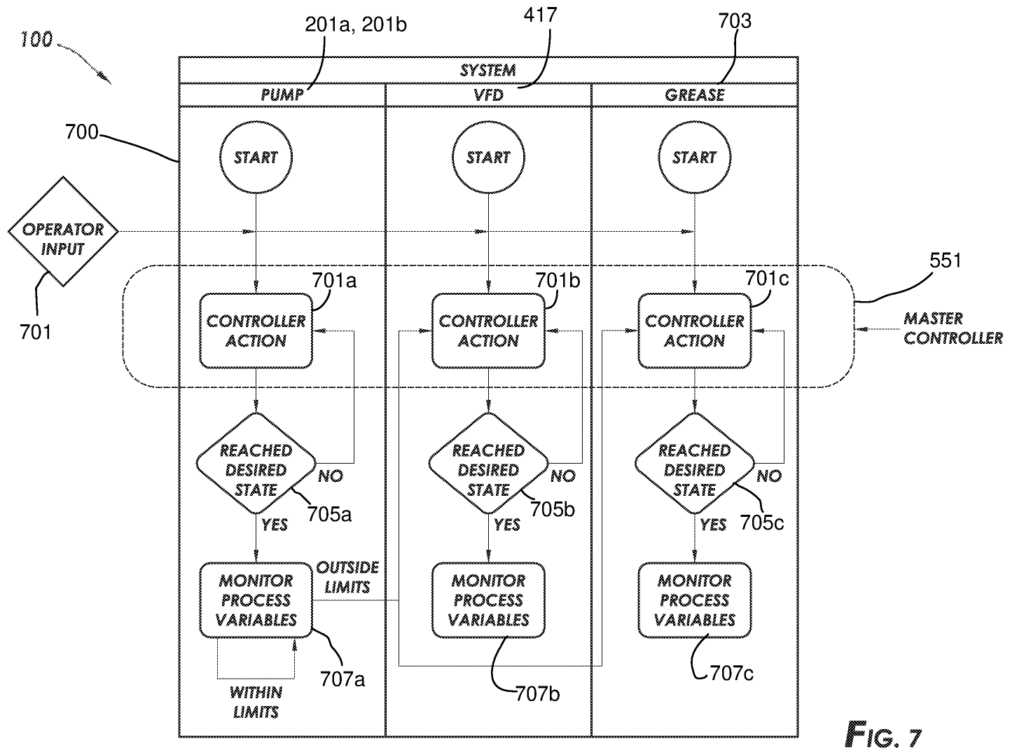

For example and without limitation, FIG. 7 depicts decision flow tree 700 consistent with at least one embodiment of the present disclosure. Once integrated fracturing system 100 is in operation, master controller 551 may receive operator input 701, and may undertake controller actions (701a-c) to control the operation of subsystems of integrated fracturing system 100 including fracturing pumps 201a, 201b; VFD 417; and other subsystems of integrated fracturing system 100 such as, for example and without limitation, grease system 703 as shown in FIG. 7. Master controller 551 may continue to operate and determine whether each such subsystem has reached a desired state (705a-c). Once such a state has been reached, process variables for each subsystem may be monitored (707a-c). In the case that one such process variable is out of limits, such as, for example and without limitation, process variables (707a) relating to fracturing pumps 201a, 201b, master controller 551 may take an action to change the operation of other subsystems of integrated fracturing system 100, such as controller action 701b related to the operation of VFD 417, and controller action 701c related to the operation of grease system 703.

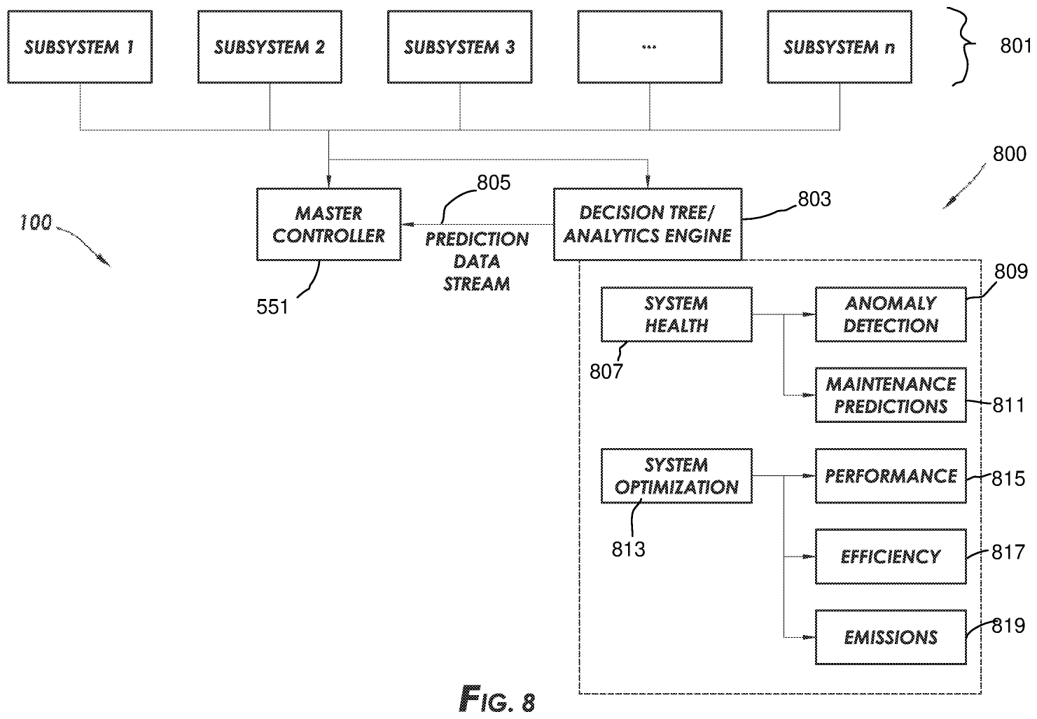

For example and without limitation, FIG. 8 depicts decision flow tree 800 consistent with at least one embodiment of the present disclosure. Master controller 551 may receive data from multiple subsystems 801, which may be fed into decision tree/analytics engine 803. Decision tree/analytics engine 803 may feed prediction data stream 805 to master controller 551 such that master controller 551 may operate subsystems 801 consistent with decision tree/analytics engine 803. For example, decision tree/analytics engine 803 may be used, as discussed herein above, to manage system health 807, which may include anomaly detection 809 and maintenance predictions 811. Similarly, decision tree/analytics engine 803 may be used to optimize performance, shown as system optimization 813, which may include, for example and without limitation, performance optimization 815, efficiency 817, and managing emissions 819.

The foregoing outlines features of several embodiments so that a person of ordinary skill in the art may better understand the aspects of the present disclosure. Such features may be replaced by any one of numerous equivalent alternatives, only some of which are disclosed herein. One of ordinary skill in the art should appreciate that they may readily use the present disclosure as a basis for designing or modifying other processes and structures for carrying out the same purposes and/or achieving the same advantages of the embodiments introduced herein. One of ordinary skill in the art should also realize that such equivalent constructions do not depart from the spirit and scope of the present disclosure and that they may make various changes, substitutions, and alterations herein without departing from the spirit and scope of the present disclosure.

1. An integrated fracturing system comprising:
a fracturing pump;
an electric motor positioned to drive the fracturing pump;
a variable frequency drive positioned to provide variable frequency power to the electric motor;
a master controller, the master controller positioned to provide energize and speed commands to the VFD; and
a diagnostic sensor coupled to the electric motor positioned to measure diagnostic data, the diagnostic sensor in communication with the master controller.

2. The integrated fracturing system of claim 1, wherein the diagnostic sensor comprises a speed sensor.

3. The integrated fracturing system of claim 1, wherein the diagnostic sensor provides diagnostic data to the master controller, the diagnostic data being motor bearing drive-end temperature, motor bearing non-drive-end temperature, motor RPM, motor feedback hertz, motor winding A temperature, motor winding B temperature, or motor winding C temperature.

4. The integrated fracturing system of claim 1, further comprising a second diagnostic sensor.

5. The integrated fracturing system of claim 4, wherein the second diagnostic sensor is a pressure transducer, temperature transducer, speed sensor, or power measurement device.

6. The integrated fracturing system of claim 4, wherein the second diagnostic sensor provides diagnostic data to the master controller, the diagnostic data being battery voltage; coolant pressure; coolant temperature; discharge pressure; discharge rate; fluid end strokes; grease system active; number of plungers; overpressure trip point; plunger diameter; plunger stroke; power end strokes; pump charge pressure; pump efficiency; pump gear ratio; pump hours; pump id; pump lube oil pressure; pump lube oil temperature; pump discharge total; motor RPM request; VFD current DAC; VFD current RPM; VFD drive current percent; VFD overload percent remaining; VFD frequency feedback hertz; VFD maximum RPM; VFD motor current amperes; VFD motor overload percent remaining; VFD motor power kW; VFD motor voltage; VFD speed feedback percent; VFD speed feedback RPM; VFD CDC temperature; VFD IGBT bridge 1 temperature; VFD IGBT bridge 2 temperature; VFD IGBT bridge 3 temperature; VFD rectifier bridge temperature; VFD maximum CDC temperature; VFD active current amperes; VFD reactive current amperes; VFD speed reference percent; VFD torque demand percent; or remote watchdog enabled.

7. The integrated fracturing system of claim 1, further comprising a system controller, the system controller in communication with the master controller.

8. The integrated fracturing system of claim 7, wherein the system controller provides diagnostic data to the master controller, the diagnostic data being information from a fan controller, pressure transducer associated with a pump, accelerometer associated with a pump, lube oil pressures and temperature sensors, motor bearing temperature sensors, and motor winding temperature sensors.

9. The integrated fracturing system of claim 1, wherein the diagnostic data is provided to the master controller and not the VFD.

10. A method comprising:
providing an integrated fracturing system, the integrated fracturing system including:
a fracturing pump;
an electric motor positioned to drive the fracturing pump;
a variable frequency drive positioned to provide variable frequency power to the electric motor;
a master controller, the master controller positioned to provide energize and speed commands to the VFD; and
a diagnostic sensor positioned to measure diagnostic data, the diagnostic sensor in communication with the master controller;
providing diagnostic data from the diagnostic sensor to the master controller; and
performing diagnostics with the master controller and not the VFD.

11. The method of claim 10, wherein diagnostics comprises one or more of troubleshooting issues, building predictive models for forensic analysis, optimized performance, managing of health of components, and for generating preventative decision tress for safety and reliability.

12. The method of claim 10, wherein diagnostic data comprises one or more of battery voltage;
motor bearing drive-end temperature; motor bearing non-drive-end temperature; coolant pressure; coolant temperature; discharge pressure; discharge rate; fluid end strokes; grease system active; motor RPM; motor feedback hertz; number of plungers; overpressure trip point; plunger diameter; plunger stroke; power end strokes; pump charge pressure; pump efficiency; pump gear ratio; pump hours; pump id; pump lube oil pressure; pump lube oil temperature; pump discharge total; motor RPM request; VFD current DAC; VFD current RPM; VFD drive current percent; VFD overload percent remaining; VFD frequency feedback hertz; VFD maximum RPM; VFD motor current amperes; VFD motor overload percent remaining; VFD motor power kW; VFD motor voltage; VFD speed feedback percent; VFD speed feedback RPM; VFD CDC temperature; VFD IGBT bridge 1 temperature; VFD IGBT bridge 2 temperature; VFD IGBT bridge 3 temperature; VFD rectifier bridge temperature; VFD maximum CDC temperature; VFD active current amperes; VFD reactive current amperes; VFD speed reference percent; VFD torque demand percent; remote watchdog enabled; motor winding A temperature; motor winding B temperature; motor winding C temperature.

13. The method of claim 10, further comprising:
receiving input from an operator, with the master controller, of desired speed or rate of flow of the fracturing pump;
interpreting the input from the operator with the master controller; and
outputting, with the master controller, energize and speed commands to the VFD.

14. The method of claim 10, further comprising providing alerts, with the master controller, to a user according to an alert condition.

15. The method of claim 14, wherein the alert condition is based on the monitoring of one or more of motor bearing drive end; motor bearing non-drive end; motor blower; coolant fan motor; coolant level; coolant recirculation motor; coolant pressure; coolant temperature; emergency stop; grease level low; lube oil level; phase A winding temperature; phase B winding temperature; phase C winding temperature; pump charge pressure; pump discharge pressure; pump oil pressure; pump oil temperature; pump speed; shutdown; VFD fault; watchdog local timeout; or watchdog remote timeout.
